(19) United States
(12) Patent Application Publication
(10) Pub. No.: US 2026/0107029 A1
(43) Pub. Date: Apr. 16, 2026

(54) OPPORTUNISTIC FETCHING ALGORITHMS IN LIVE STREAMING SYSTEMS

(71) Applicant: NETFLIX, INC., Los Gatos, CA (US)

(72) Inventors: Xiaomei LIU, Cupertino, CA (US); Christopher Alan NEWTON, North Richland Hills, TX (US); Sergey FEDOROV, Los Gatos, CA (US)

(21) Appl. No.: 19/354,729

(22) Filed: Oct. 9, 2025

Related U.S. Application Data
(60) Provisional application No. 63/707,659, filed on Oct. 15, 2024.

(51) Int. Cl. H04N 21/239; H04N 21/2187; H04N 21/262

(52) U.S. Cl. CPC H04N 21/2393; H04N 21/2187; H04N 21/26208

(57) ABSTRACT

In various embodiments, a computer-implemented method for processing requests for media content segments in a live streaming system includes receiving, from an endpoint device, a request for a segment of media content. An expected generation time associated with the segment is used to establish a first timing threshold and a second timing threshold. If the request is received between the first and second thresholds, then a request for the segment is transmitted to a preferred pipeline among multiple pipelines, and the segment is returned if available from the preferred pipeline or an error is returned if the segment is unavailable. If the request is received after the second threshold, a request for the segment is transmitted to at least one pipeline among the multiple pipelines, and the segment is returned if available from any pipeline or an error is returned if the segment is unavailable from all pipelines.

### CROSS-REFERENCE TO RELATED APPLICATIONS

This application claims the benefit of U.S. Provisional Application titled “TECHNIQUES FOR IMPLEMENTING OPPORTUNISTIC FETCHING ALGORITHMS,” filed on October 15, 2024, and having Serial No. 63/707,659. The subject matter of this related application is hereby incorporated herein by reference.

### BACKGROUND

### FIELD OF THE VARIOUS EMBODIMENTS

Embodiments of the present disclosure relate generally to computer science and video processing and, more specifically, to opportunistic fetching algorithms in live streaming systems.

### DESCRIPTION OF THE RELATED ART

Live video streaming systems often deploy multiple redundant pipelines in order to ensure reliable delivery of content during live events. Each pipeline includes a source, an encoder, and a packager that together generate media segments, and each pipeline generates and provides the media segments to a different geographically distributed origin service. The origin service stores the packaged segments generated by the corresponding pipeline so that the segments can be retrieved when requested. The origin service receives segment requests at scale, determines from which pipeline the requested segment should be obtained, and returns the requested segment for delivery to one or more endpoint devices for playback.

The above approach suffers from different technical drawbacks. In particular, if a preferred pipeline has not yet generated a requested segment, then the origin service may obtain the requested segment from a backup pipeline. However, because the pipelines may not be perfectly time-synchronized and are not fully interchangeable, such a switchover can cause “ping-ponging” between pipelines. Ping-ponging occurs when an endpoint device issues successive requests for sequential segments and receives some segments sourced from a preferred pipeline and other segments sourced from a backup pipeline. As a result, the endpoint device receives a sequence of segments originating from different pipelines, which can introduce timing differences, frame alignment issues, or other inconsistencies that manifest as playback artifacts such as jitter, stutter, dropped frames, or audio discontinuities that are perceptible to viewers. In addition, when many endpoint devices generate large volumes of segment requests before the requested segments are available, the origin service must perform repeated checks across multiple pipelines that fail to return usable results. Such repeated checks waste processing cycles and database lookups, which consume system resources and increase the difficulty of handling valid segment requests efficiently. Accordingly, the above approach oftentimes results in a tradeoff among consistency, latency, and efficiency of resource utilization.

As the foregoing illustrates, what is needed in the art are more effective techniques for delivering content to endpoint devices when streaming live events.

### SUMMARY

In various embodiments, a computer-implemented method for processing requests for media content segments in a live video streaming system includes receiving, from an endpoint device, a first request for a segment of media content; determining, based on an expected generation time associated with the segment, a first timing threshold and a second timing threshold; if the first request is received between the first timing threshold and the second timing threshold, then: transmitting a second request for the segment to a preferred pipeline included in a plurality of pipelines, and returning the segment to the endpoint device if the segment is available from the preferred pipeline, or returning an error to the endpoint device if the segment is not available from the preferred pipeline; and if the first request is received after the second timing threshold, then: transmitting a third request for the segment to at least one pipeline included in the plurality of pipelines, and returning the segment to the endpoint device if the segment is available from any pipeline included in the plurality of pipelines, or returning an error to the endpoint device if the segment is not available from any of the pipelines included in the plurality of pipelines.

One technical advantage of the disclosed techniques relative to prior approaches is that the disclosed techniques improve consistency of pipeline selection and efficiency of request handling in live streaming systems. By preventing segment requests from being prematurely satisfied by backup pipelines, the disclosed techniques reduce “ping-ponging,” in which segment retrieval alternates between pipelines that are not time-synchronized or fully interchangeable. Reducing pipeline ping-ponging preserves uniform sourcing of consecutive segments and lowers the likelihood of timing differences, frame alignment mismatches, or encoding inconsistencies that manifest as jitter, stutter, dropped frames, or audio discontinuities during playback. The disclosed techniques also reduce wasted processing when requested segments are not yet available by rejecting premature segment requests and deferring retrieval from backup pipelines until retrieval is likely to succeed. Reducing unnecessary retrieval attempts lowers the volume of unsuccessful database lookups, conserves processing resources, and improves responsiveness for segment requests that arrive at appropriate times.

These technical advantages provide one or more technological advancements over prior art approaches.

### BRIEF DESCRIPTION OF THE DRAWINGS

So that the manner in which the above recited features of the various embodiments can be understood in detail, a more particular description of the inventive concepts, briefly summarized above, may be had by reference to various embodiments, some of which are illustrated in the appended drawings. It is to be noted, however, that the appended drawings illustrate only typical embodiments of the inventive concepts and are therefore not to be considered limiting of scope in any way, and that there are other equally effective embodiments.

FIG. 1 illustrates a network infrastructure used to distribute content to content servers and endpoint devices, according to various embodiments;

FIG. 2 is a more detailed block diagram of the content server of FIG. 1, according to various embodiments;

FIG. 3 is a more detailed block diagram of the control server of FIG. 1, according to various embodiments;

FIG. 4 is a more detailed block diagram of the endpoint device of FIG. 1, according to various embodiments;

FIG. 5 illustrates an example network infrastructure for serving live media segments to the endpoint devices of FIG. 1, according to some embodiments;

FIG. 6 illustrates an example timing diagram for evaluating segment requests in the example architecture described in conjunction with FIG. 5, according to some embodiments; and

FIG. 7 illustrates an example flow diagram for processing segment requests in the example architecture described in conjunction with FIG. 5, according to some embodiments.

### DETAILED DESCRIPTION

In the following description, numerous specific details are set forth to provide a more thorough understanding of the various embodiments. However, it will be apparent to one skilled in the art that the inventive concepts may be practiced without one or more of these specific details.

As described herein, live video streaming systems often deploy multiple redundant pipelines to provide reliable delivery of content during live events. Each pipeline includes a source, an encoder, and a packager that together generate media segments, and each pipeline delivers the media segments to a geographically distributed origin service that stores the segments for retrieval. The origin service receives segment requests at scale, determines from which pipeline the requested segment should be obtained, and returns the requested segment for delivery to endpoint devices for playback.

Conventional approaches, however, suffer from technical drawbacks. When a preferred pipeline has not yet generated a requested segment, the origin service may obtain the segment from a backup pipeline, which can cause “ping-ponging” in which segment retrieval alternates between pipelines that are not time-synchronized or fully interchangeable. An endpoint device receiving such a sequence of segments may encounter timing differences, frame alignment mismatches, or encoding inconsistencies, which manifest as playback artifacts such as jitter, stutter, dropped frames, or audio discontinuities perceptible to viewers. Furthermore, when many endpoint devices issue large volumes of requests before the requested segments are available, the origin service performs repeated checks across multiple pipelines that fail to return usable results, which wastes processing cycles and database lookups and increases the difficulty of handling valid segment requests efficiently. As a result, the prior approach often produces a tradeoff among consistency, latency, and efficiency of resource utilization.

Accordingly, the disclosed techniques provide a live streaming system in which multiple redundant pipelines generate and provide packaged media segments to geographically distributed origin services. Each origin service determines from which pipeline a requested segment should be obtained. The disclosed techniques improve upon prior approaches by introducing a structured retrieval process that defines two timing boundaries relative to the expected availability of each segment. A first boundary is defined as the expected segment-availability time plus a jitter guard time, and a second boundary is defined as the expected segment-availability time plus a longer deadline.

Requests that arrive before the first boundary are rejected with a HyperText Transfer Protocol (HTTP) 404 not-found response, which helps to prevent premature lookups and avoid unnecessary database queries when a segment cannot yet be available. Requests that arrive between the first boundary and the second boundary are handled opportunistically by performing a single fetch from a preferred pipeline. If the segment is available through the preferred pipeline, then the segment is retrieved from the preferred pipeline. Conversely, if the segment is not available through the preferred pipeline, then the request is rejected with an HTTP 404 not-found response, and no further pipeline scanning is carried out. Requests that arrive after the second boundary trigger a successive pipeline scan, in which the origin service checks the pipelines in a fixed order until a valid segment is located. If the segment cannot be obtained from the pipelines, then an HTTP 404 not-found response is returned.

One technical advantage of the disclosed techniques relative to prior approaches is that the disclosed techniques improve consistency of pipeline selection and efficiency of request handling in live streaming systems. By preventing segment requests from being prematurely satisfied by backup pipelines, the disclosed techniques reduce “ping-ponging,” in which segment retrieval alternates between pipelines that are not time-synchronized or fully interchangeable. This issue is particularly relevant in systems with geographically distributed pipelines and origin service locations, where origin servers that are co-located or closely located to a backup pipeline may deliver segments earlier than those from a more distant primary pipeline due to network transmission times. Reducing pipeline ping-ponging preserves uniform sourcing of consecutive segments and lowers the likelihood of timing differences, frame alignment mismatches, or encoding inconsistencies that manifest as jitter, stutter, dropped frames, or audio discontinuities during playback. The disclosed techniques also reduce wasted processing when requested segments are not yet available by rejecting premature segment requests and deferring retrieval from backup pipelines until retrieval is likely to succeed. Reducing unnecessary retrieval attempts lowers the volume of unsuccessful database lookups, conserves processing resources, and improves responsiveness for segment requests that arrive at appropriate times. These technical advantages provide one or more technological advancements over prior art approaches.

### System Overview

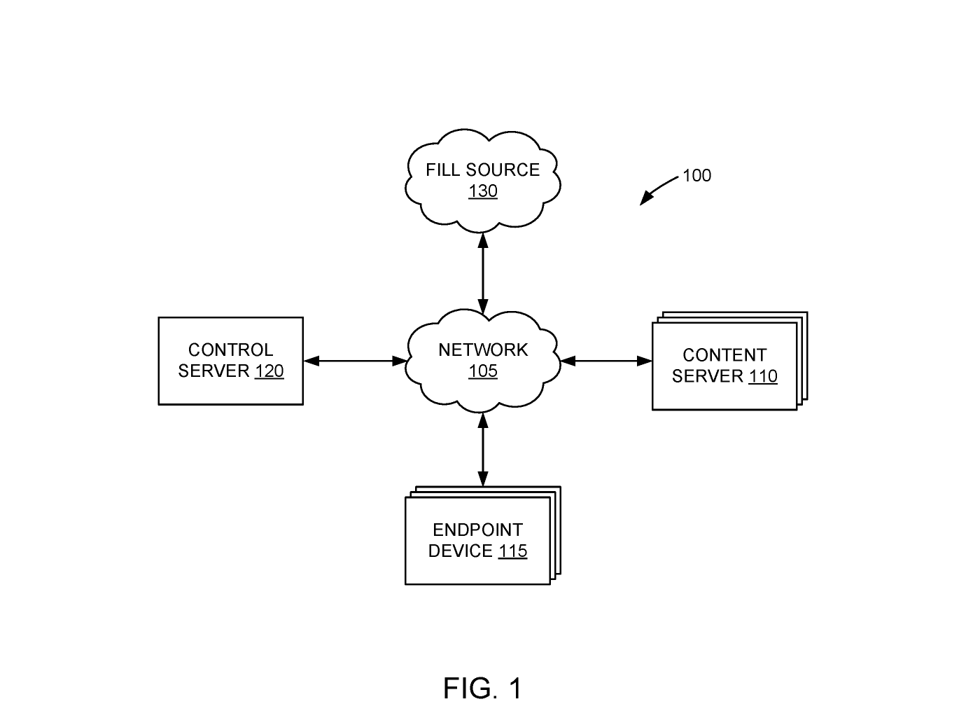

FIG. 1 illustrates a network infrastructure 100 used to distribute content to content servers 110 and endpoint devices 115, according to various embodiments. As shown, the network infrastructure 100 includes content servers 110, control server 120, and endpoint devices 115, each of which are connected via a communications network 105. The network 105 can represent, for example, any technically feasible network or number of networks, including a wide area network (WAN) such as the Internet, a local area network (LAN), a Wi-Fi network, a cellular network, or a combination thereof.

Each endpoint device 115 communicates with one or more content servers 110 (also referred to as “caches” or “nodes”) via the network 105 to download content, such as textual data, graphical data, audio data, video data, and other types of data. The downloadable content, also referred to herein as a “file,” is then presented to a user of one or more endpoint devices 115. In various embodiments, the endpoint devices 115 may include computer systems, set top boxes, mobile computer, smartphones, tablets, console and handheld video game systems, digital video recorders (DVRs), DVD players, connected digital TVs, dedicated media streaming devices, (e.g., the Roku® set-top box), and/or any other technically feasible computing platform that has network connectivity and is capable of presenting content, such as text, images, video, and/or audio content, to a user.

Each content server 110 may include a web-server, a database, and a server application configured to communicate with the control server 120 to determine the location and availability of various files that are tracked and managed by the control server 120. Each content server 110 may further communicate with a fill source 130 and one or more other content servers 110 in order to “fill” each content server 110 with copies of various files. In addition, content servers 110 may respond to requests for files received from endpoint devices 115. The files may then be distributed from the content server 110 or via a broader content distribution network. In some embodiments, the content servers 110 enable users to authenticate (e.g., using a username and password) in order to access files stored on the content servers 110. Although only a single control server 120 is shown in FIG. 1, in various embodiments multiple control servers 120 may be implemented to track and manage files.

In various embodiments, the fill source 130 may include an online storage service (e.g., Amazon® Simple Storage Service, Google® Cloud Storage, etc.) in which a catalog of files, including thousands or millions of files, is stored and accessed in order to fill the content servers 110. Although only a single fill source 130 is shown in FIG. 1, in various embodiments multiple fill sources 130 may be implemented to service requests for files. Further, as is well-understood, any cloud-based services can be included in the architecture of FIG. 1 beyond fill source 130 to the extent desired or necessary.

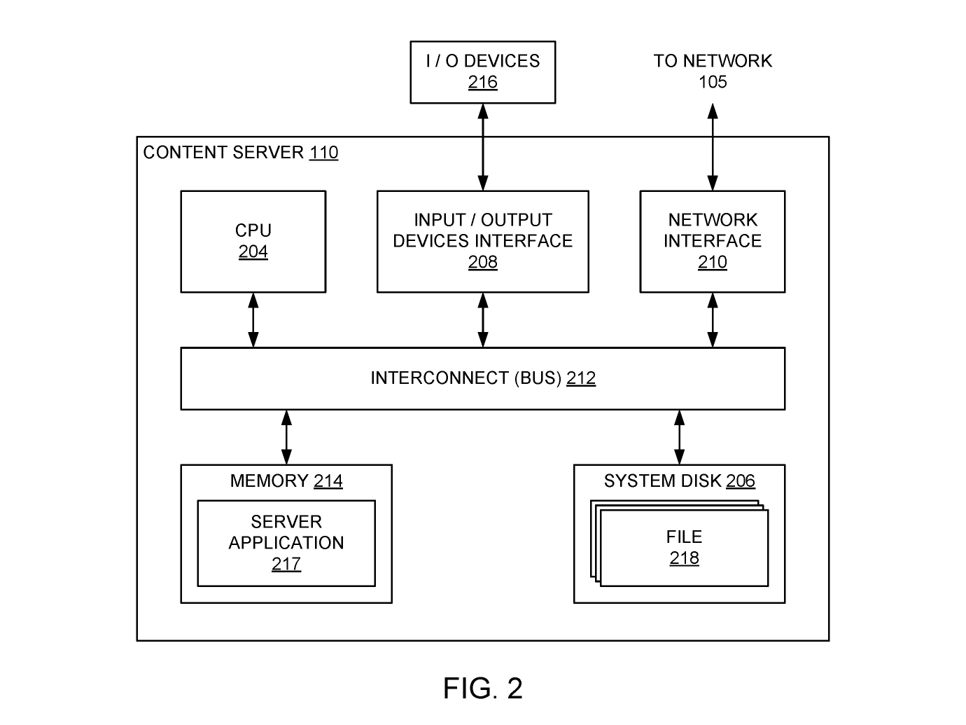

FIG. 2 is a block diagram of a content server 110 that may be implemented in conjunction with the network infrastructure 100 of FIG. 1, according to various embodiments. As shown, the content server 110 includes, without limitation, a central processing unit (CPU) 204, a system disk 206, an input/output (I/O) devices interface 208, a network interface 210, an interconnect 212, and a system memory 214.

The CPU 204 is configured to retrieve and execute programming instructions, such as server application 217, stored in the system memory 214. Similarly, the CPU 204 is configured to store application data (e.g., software libraries) and retrieve application data from the system memory 214. The interconnect 212 is configured to facilitate transmission of data, such as programming instructions and application data, between the CPU 204, the system disk 206, I/O devices interface 208, the network interface 210, and the system memory 214. The I/O devices interface 208 is configured to receive input data from I/O devices 216 and transmit the input data to the CPU 204 via the interconnect 212. For example, I/O devices 216 may include one or more buttons, a keyboard, a mouse, and/or other input devices. The I/O devices interface 208 is further configured to receive output data from the CPU 204 via the interconnect 212 and transmit the output data to the I/O devices 216.

The system disk 206 may include one or more hard disk drives, solid state storage devices, or similar storage devices. The system disk 206 is configured to store non-volatile data such as files 218 (e.g., audio files, video files, subtitles, application files, software libraries, etc.). The files 218 can then be retrieved by one or more endpoint devices 115 via the network 105. In some embodiments, the network interface 210 is configured to operate in compliance with the Ethernet standard.

The system memory 214 includes a server application 217 configured to service requests for files 218 received from endpoint device 115 and other content servers 110. When the server application 217 receives a request for a file 218, the server application 217 retrieves the corresponding file 218 from the system disk 206 and transmits the file 218 to an endpoint device 115 or a content server 110 via the network 105.

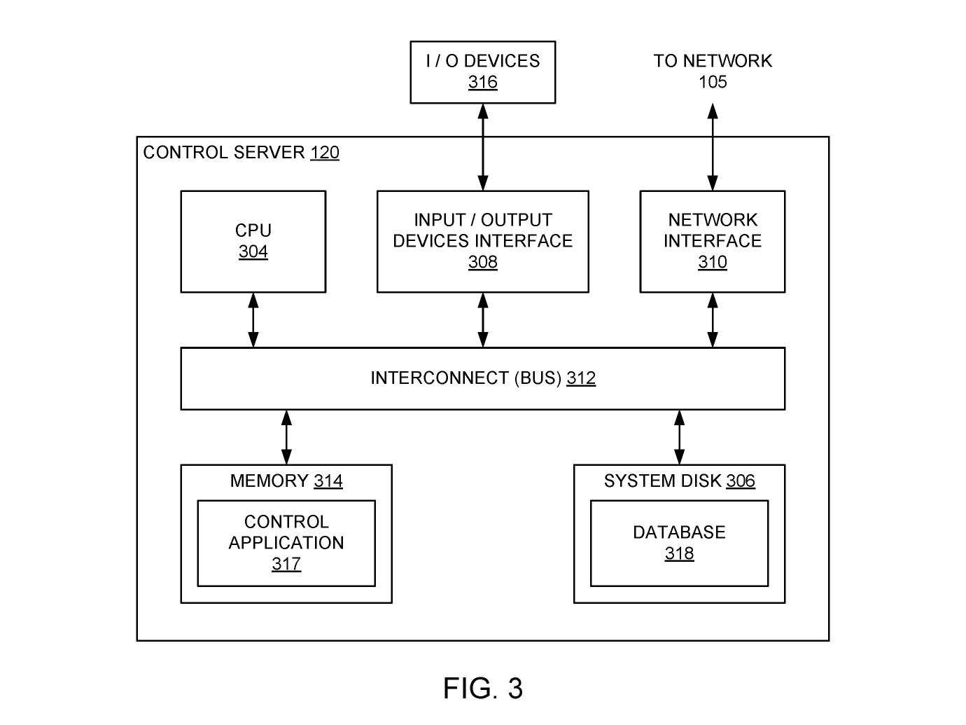

FIG. 3 is a block diagram of a control server 120 that may be implemented in conjunction with the network infrastructure 100 of FIG. 1, according to various embodiments. As shown, the control server 120 includes, without limitation, a central processing unit (CPU) 304, a system disk 306, an input/output (I/O) devices interface 308, a network interface 310, an interconnect 312, and a system memory 314.

The CPU 304 is configured to retrieve and execute programming instructions, such as control application 317, stored in the system memory 314. Similarly, the CPU 304 is configured to store application data (e.g., software libraries) and retrieve application data from the system memory 314 and a database 318 stored in the system disk 306. The interconnect 312 is configured to facilitate transmission of data between the CPU 304, the system disk 306, I/O devices interface 308, the network interface 310, and the system memory 314. The I/O devices interface 308 is configured to transmit input data and output data between the I/O devices 316 and the CPU 304 via the interconnect 312. The system disk 306 may include one or more hard disk drives, solid state storage devices, and the like. The system disk 306 is configured to store a database 318 of information associated with the content servers 110, the fill source(s) 130, and the files 218.

The system memory 314 includes a control application 317 configured to access information stored in the database 318 and process the information to determine the manner in which specific files 218 will be replicated across content servers 110 included in the network infrastructure 100. The control application 317 may further be configured to receive and analyze performance characteristics associated with one or more of the content servers 110 and/or endpoint devices 115.

Referring generally to FIGS. 1-3, in various embodiments, the system 100 is configured to implement an encoding pipeline (also referred to as an “encoder”) to compress audiovisual content associated with media titles prior to streaming to endpoint device(s) 115. For example, and without limitation, the control server 120 of FIGS. 1 and 3 could implement an encoding pipeline via control application 317 that compresses files 218 prior to transmission to an endpoint device 115. Alternatively, and without limitation, files stored in fill source 130 could be compressed, via an encoding pipeline within system 100, prior to storage.

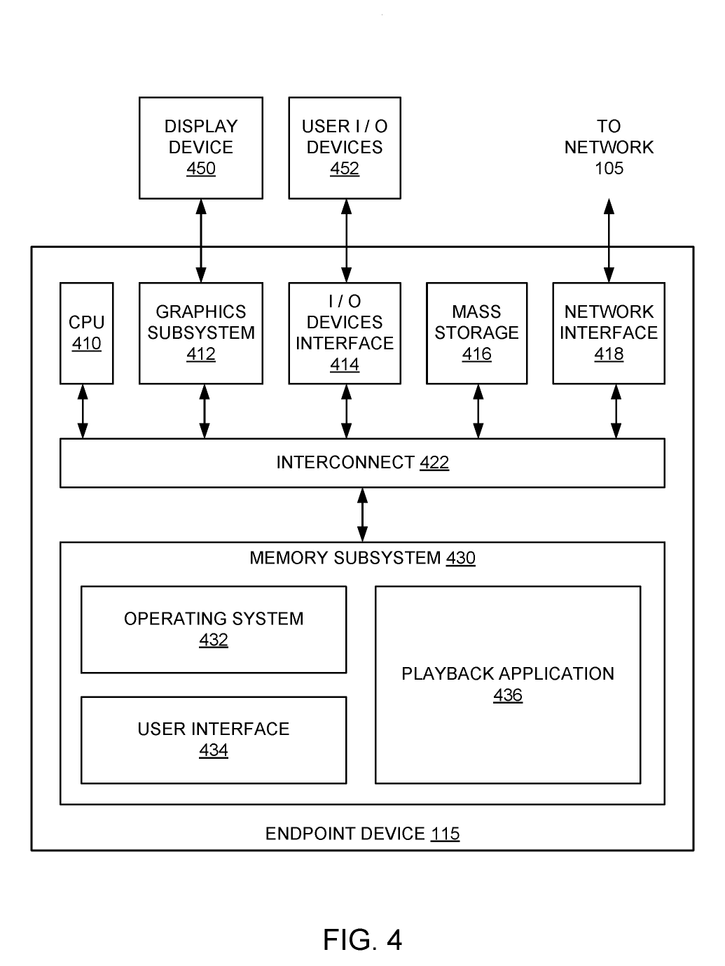

FIG. 4 is a block diagram of an endpoint device 115 that may be implemented in conjunction with the network infrastructure 100 of FIG. 1, according to various embodiments of the present invention. As shown, the endpoint device 115 may include, without limitation, a CPU 410, a graphics subsystem 412, an I/O device interface 414, a mass storage 416, a network interface 418, an interconnect 422, and a memory subsystem 430.

In some embodiments, the CPU 410 is configured to retrieve and execute programming instructions stored in the memory subsystem 430. Similarly, the CPU 410 is configured to store and retrieve application data (e.g., software libraries) residing in the memory subsystem 430. The interconnect 422 is configured to facilitate transmission of data, such as programming instructions and application data, between the CPU 410, graphics subsystem 412, I/O devices interface 414, mass storage 416, network interface 418, and memory subsystem 430.

In some embodiments, the graphics subsystem 412 is configured to generate frames of video data and transmit the frames of video data to display device 450. In some embodiments, the graphics subsystem 412 may be integrated into an integrated circuit, along with the CPU 410. The display device 450 may comprise any technically feasible means for generating an image for display. For example, the display device 450 may be fabricated using liquid crystal display (LCD) technology, cathode-ray technology, and light-emitting diode (LED) display technology. An input/output (I/O) device interface 414 is configured to receive input data from user I/O devices 452 and transmit the input data to the CPU 410 via the interconnect 422. For example, user I/O devices 452 may comprise one of more buttons, a keyboard, and a mouse or other pointing device. The I/O device interface 414 also includes an audio output unit configured to generate an electrical audio output signal. User I/O devices 452 includes a speaker configured to generate an acoustic output in response to the electrical audio output signal. In alternative embodiments, the display device 450 may include the speaker. A television is an example of a device known in the art that can display video frames and generate an acoustic output.

A mass storage 416, such as a hard disk drive or flash memory storage drive, is configured to store non-volatile data. A network interface 418 is configured to transmit and receive packets of data via the network 105. In some embodiments, the network interface 418 is configured to communicate using the well-known Ethernet standard. The network interface 418 is coupled to the CPU 410 via the interconnect 422.

In some embodiments, the memory subsystem 430 includes programming instructions and application data that comprise an operating system 432, a user interface 434, and a playback application 436. The operating system 432 performs system management functions such as managing hardware devices including the network interface 418, mass storage 416, I/O device interface 414, and graphics subsystem 412. The operating system 432 also provides process and memory management models for the user interface 434 and the playback application 436. The user interface 434, such as a window and object metaphor, provides a mechanism for user interaction with endpoint device 115. Persons skilled in the art will recognize the various operating systems and user interfaces that are well-known in the art and suitable for incorporation into the endpoint device 115.

In some embodiments, the playback application 436 is configured to request and receive content from the content server 110 via the network interface 418. Further, the playback application 436 is configured to interpret the content and present the content via display device 450 and/or user I/O devices 452. In one embodiment, the playback application 436 may include a decoding pipeline that decodes compressed content prior to display via display device.

### Opportunistic Fetching Algorithms

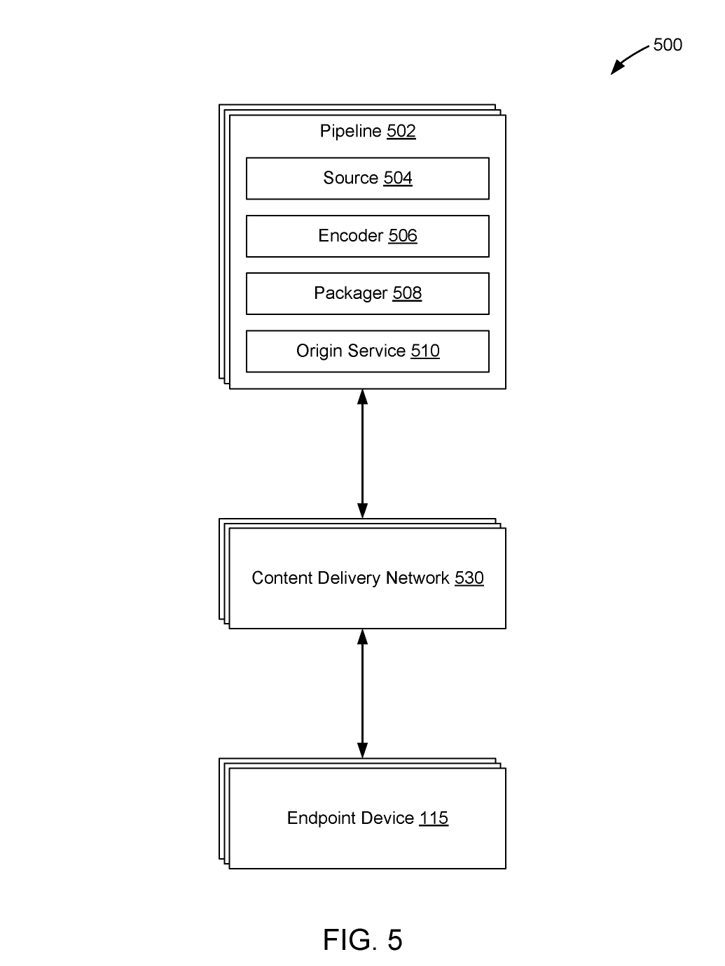

FIG. 5 illustrates an example network infrastructure 500 for serving live media segments to the endpoint devices of FIG. 1, according to some embodiments. Network infrastructure 500 includes pipelines 502, a content delivery network (CDN) 530, and endpoint devices 115. More specifically, the example network infrastructure 500 demonstrates how the pipelines 502 generate media segments, how the origin service 510 manages retrieval of the media segments, and how the CDN 530 and the endpoint devices 115 can interact to enable playback of live events at scale.

As a brief aside, it will be understood that the network infrastructure 500 may form any technically feasible portion of, or extension to, the network infrastructure 100 shown in FIG. 1. In some implementations, geographically distributed instances of the network infrastructure 500 may include the origin services 510 without at least one of the source 504, encoder 506, or packager 508 components. Further, various components of the network infrastructure 500 can be implemented via the different components of the network infrastructure 100 described above in conjunction with FIGS. 1-4. For example, in various embodiments, origin services 510 may be implemented via one or more fill sources 130, and/or CDNs 530 may be implemented via one or more content servers 110. Various components of the network infrastructure 100 and/or network infrastructure 500 may form a portion of a control plane, such as the control server 120, for example and without limitation, while other components of the network infrastructure 100 or network infrastructure 500 may form a portion of a data plane, such as the origin services 510, for example and without limitation.

As shown in FIG. 5, each pipeline 502 includes a source 504, an encoder 506, a packager 508, and an origin service 510. The source 504 provides continuous audiovisual input such as a live broadcast feed, a captured event, or another real-time content stream. The encoder 506 receives the audiovisual input from the source 504 and compresses the audiovisual input into a digital bitstream using a codec such as H.264 or HEVC, thereby generating a stream that can be efficiently transported and decoded by downstream devices. Under one example approach, the packager 508 receives the compressed stream from the encoder 506 and divides the compressed stream into media segments of fixed duration, for example two-second media segments. Under another example approach, the encoder 506 can perform segmentation operations, and the packager 508 can perform digital rights management (DRM) operations or other system-level stream manipulation operations. It should be appreciated that the foregoing examples are not meant to be limiting, and that the encoder 506 and the packager 508 can be configured to perform any number, type, form, etc., of operations, at any level of granularity, consistent with the scope of this disclosure.

In some embodiments, the packager 508 generates a playlist or manifest that describes the sequence of the media segments, which allows downstream devices to identify the next expected segment identifier based on playback time. The media segments generated by the packager 508 are stored by an origin service 510, which responds to retrieval requests for the stored media segments to make the media segments accessible to downstream components.

Each pipeline 502 is typically deployed in a unique geographic region such as a data center in the eastern United States, a data center in the western United States, or a data center in another territory. Geographic separation of the pipelines 502 provides redundancy, which can promote continued availability of media segments even when one geographic region experiences a network failure or delay. Multiple pipelines 502 deployed across different regions also enable load balancing and resiliency against large-scale events such as cloud provider outages, encoder failures, or the like.

According to some embodiments, the packagers 508 can generate media segments in adaptive bitrate (ABR) formats such as HLS or MPEG-DASH, which support different encoding qualities for the same segment identifier. Each segment identifier may therefore reference multiple encoded versions, thereby enabling endpoint devices 115 to adapt playback quality dynamically to changing network conditions. The origin services 510 may store the segments in key-value stores, object storage systems, or distributed databases that allow efficient retrieval through segment identifier lookups. The origin services 510 can also maintain indexes that record the latest generated segment identifier for each pipeline 502.

According to some embodiments, the origin service 510 receives segment requests that are forwarded by the CDN 530 (e.g., on behalf of endpoint devices 115) and determines from which pipeline 502 a requested segment should be obtained. The origin service 510 applies decision logic based on timing thresholds that correspond to the expected availability of each segment.

The origin service 510 calculates timing thresholds that are used to evaluate incoming segment requests. In an example configuration, a first threshold T1 is calculated as a slower generation time among two pipelines 502 assigned to a geographic area, where the slower generation time is derived from a first segment arrival time observed for the pipelines 502, a segment duration associated with the media segments, and a requested segment identifier. The slower generation time is then increased by a configurable jitter guard, e.g., 100 milliseconds. A second threshold T2 is calculated as the slower generation time among the two encoders based on the first segment arrival time, the segment duration, and the requested segment identifier, which is then increased by a configurable deadline, e.g., three seconds. When additional pipelines 502 are deployed, the slower generation time may be determined among the pipelines 502 identified in a regional priority list maintained by the origin service 510. It is noted that the foregoing example configuration is not meant to be limiting, and that any amount, type, form, etc., of timing thresholds, at any level of granularity and based on any information, can be implemented to establish different timing windows that affect pipeline 502 selections in response to segment requests, consistent with the scope of this disclosure.

According to some embodiments, when a segment request arrives before the first threshold T1, the origin service 510 rejects the segment request immediately without performing any pipeline scan. When a segment request arrives between the first threshold T1 and the second threshold T2, the origin service 510 performs an opportunistic check of a preferred pipeline 502. If the preferred pipeline 502 has already generated the requested segment, then the origin service 510 returns the requested segment. If the preferred pipeline 502 has not yet generated the requested segment, then the origin service 510 rejects the segment request rather than falling back to another pipeline 502 prematurely. When a segment request arrives after the second threshold T2, then origin service 510 performs a sequential scan across the pipelines 502 in a fixed order of priority until the requested segment is found or until all pipelines 502 have been checked. If the segment cannot be found, then the segment request is rejected. In some implementations, once a pipeline 502 is selected during the sequential scan to serve a given segment, the origin service 510 may record that association so that subsequent requests for the same segment are fulfilled from that same pipeline 502, even if the segment later becomes available from the primary pipeline 502. Such an approach can further promote consistency in segment sourcing and playback continuity.

In some embodiments, each segment generated by a pipeline 502 can be augmented with a quality score that indicates whether any defects or degradations were observed in the source content, the encoding process, the packaging process, etc., such as visual or audio artifacts. During the pipeline 502 selection process, an acceptable-quality threshold can be applied. For example, between the first threshold T1 and a third threshold T3, the origin service 510 can return a segment from the primary pipeline 502 only when the corresponding quality score exceeds the acceptable-quality threshold. If the quality score does not exceed the acceptable-quality threshold, then the origin service 510 can return rejection responses until the third threshold T3 is reached. At the third threshold T3, the origin service 510 can perform a sequential scan across the pipelines 502 and return a segment from a less preferred pipeline 502 when the quality score associated with that segment is higher than the quality score associated with the segment from the primary pipeline 502. In some implementations, the third threshold T3 can coincide with the second threshold T2 or can occur between the first threshold T1 and the second threshold T2. A segment from a less preferred pipeline 502 can also be selected only when the quality score associated with that segment exceeds the quality score associated with the segment from the primary pipeline 502 by at least a configured quality score delta, which can promote stability and consistency in segment selection.

In some implementations, a segment request that is rejected by the origin service 510 is transmitted as a Hypertext Transfer Protocol (HTTP) 404 not-found response. The HTTP 404 response provides a standardized mechanism to indicate that the requested segment is not available at the time of the request, which allows endpoint devices 115 and the CDN 530 to handle the rejection without ambiguity. The use of an HTTP 404 response ensures compatibility with conventional HTTP-based delivery workflows, because playback applications running on endpoint devices 115 are already configured to interpret a 404 status as a signal to retry the request after a delay or to advance playback to the next segment. The origin service 510 may also include optional headers in the HTTP 404 response that indicate retry intervals or diagnostic information, which allows system operators to monitor the frequency of premature segment requests and to adjust jitter guard or deadline values accordingly.

According to some embodiments, each pipeline check performed by the origin service 510 may involve a database query or a key-value lookup, which confirms whether the requested segment is available from a given pipeline 502. Sequential scanning reduces database load relative to parallel scanning, which can be beneficial given the origin service 510 may receive thousands of requests per second. By rejecting premature requests and limiting opportunistic checks to a single preferred pipeline 502, the origin service 510 reduces unnecessary database load and only performs full scans when additional pipelines 502 are likely to contain the requested segment.

According to some embodiments, the origin service 510 maintains configuration information that defines a priority list of pipelines 502 associated with each geographic area. For example, for a geographic area such as the United States, the origin service 510 may store a priority list that includes four pipelines 502 assigned to the region: a preferred pipeline located in a local region, a preferred pipeline located in a remote region, a backup pipeline located in the local region, and a backup pipeline located in the remote region. The origin service 510 applies the stored priority list when processing segment requests from endpoint devices 115 associated with the United States, thereby ensuring that requests are consistently routed to pipelines 502 in accordance with defined regional policies. Similar priority lists may be defined for other geographic areas such as Europe or Asia, which allows the origin service 510 to adapt pipeline 502 selection to the location of requesting endpoint devices 115. The configuration information may be updated dynamically by administrators or automated systems to adjust to network conditions, encoder failures, or changing event requirements.

As shown in FIG. 5, the CDN 530 is positioned between the origin service 510 and the endpoint devices 115. Each endpoint device 115 generates segment requests during playback and transmits the segment requests to the CDN 530. When the CDN 530 contains the requested segment in cache, the CDN 530 serves the cached segment directly to the requesting endpoint device 115. When the CDN 530 does not contain the requested segment, the CDN 530 forwards the segment request to the appropriate origin service 510 for resolution.

According to some embodiments, the CDN 530 provides a caching layer and a distribution layer. The CDN 530 can collapse multiple concurrent cache-miss requests for the same segment into a single upstream request to the origin service 510, which reduces fan-out load. The CDN 530 may also enforce caching policies such as short time-to-live values, which not only prevent stale segments from being served but also support short-lived caching of rejection responses (e.g., 404 errors) to further reduce unnecessary repeat requests to the origin service 510. By absorbing large request volumes and redistributing responses, the CDN 530 enables the origin service 510 to serve the endpoint devices 115 at scale while maintaining low latency.

According to some embodiments, each endpoint device 115 represents a playback device such as a television, a mobile phone, a computer, or a set-top box. Each endpoint device 115 executes a playback application 436 that determines which segment identifiers should be available at a given wall-clock time. Each endpoint device 115 maintains a local clock and uses the local clock, together with segment duration information in a manifest, to calculate expected segment identifiers. For example, when new segments are created every two seconds, an endpoint device 115 calculates that at wall-clock time T, segment identifier N should be available. Based on this calculation, the endpoint device 115 generates a segment request for segment identifier N and transmits the segment request to the CDN 530. When the CDN 530 does not contain the requested segment, the CDN 530 forwards the segment request to the origin service 510.

Clock synchronization across endpoint devices 115 may be achieved using network time protocol (NTP), precision time protocol (PTP), or GPS-based timing. Even when endpoint devices 115 have minor clock offsets, the timing thresholds enforced by the origin service 510 ensure that requests are rejected when premature, thereby avoiding playback inconsistencies. In some embodiments, the CDN 530 may include timing information in rejection responses, which the endpoint devices 115 can use to refine a local notion of current time and correct clock offsets relative to the origin service 510.

According to some embodiments, each encoder 506 and each packager 508 generates media segments in accordance with a segment duration, which defines the cadence of segment availability. Each endpoint device 115 uses the local clock to estimate which segment identifier should be available at a given time. The origin service 510 uses the segment generation behavior of the pipelines 502 to determine timing thresholds, which establish whether a segment request should be rejected, opportunistically satisfied, or resolved through sequential searching.

Synchronization of timing behavior across the pipelines 502, the origin service 510, the CDN 530, and the endpoint devices 115 aligns segment requests with actual segment generation times. Synchronization reduces playback disruptions such as stuttering, jitter, or “ping-ponging” between unsynchronized pipelines 502. Synchronization also provides consistent segment sourcing even under high request volumes. Metrics may be collected by the origin service 510 to monitor the frequency of rejected requests, opportunistic retrievals, and sequential searches, which allows operators to tune jitter guard values and deadlines for future events.

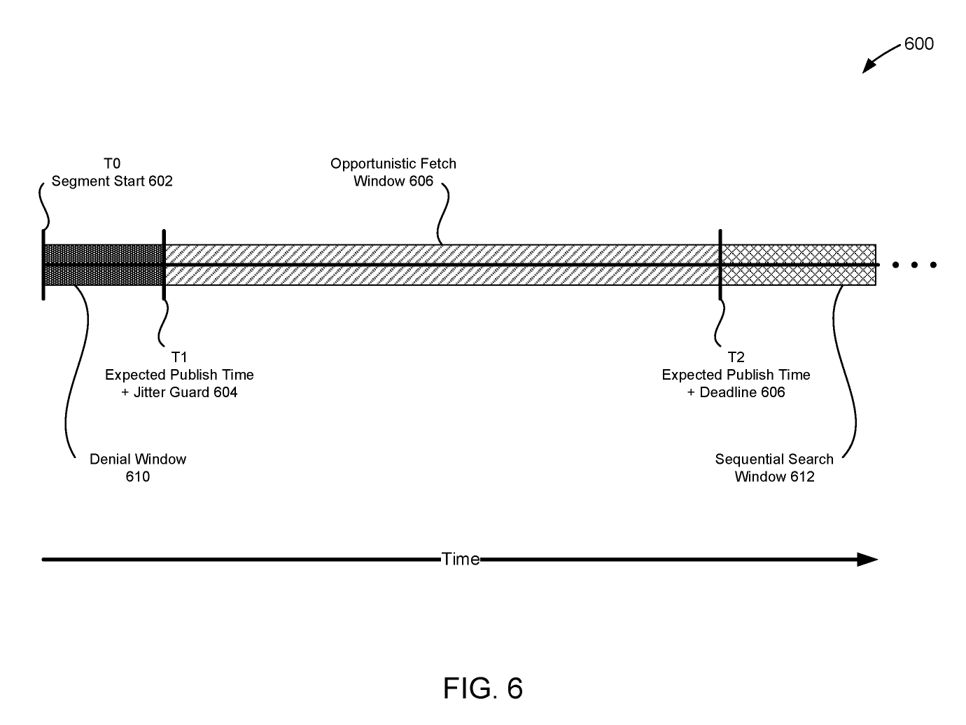

FIG. 6 illustrates an example timing diagram 600 for evaluating segment requests in the example network infrastructure 500 described in conjunction with FIG. 5, according to some embodiments. More specifically, timing diagram 600 illustrates how the origin service 510 can determine whether a segment request should be rejected, opportunistically processed, or resolved through sequential searching based on the relationship between the segment request time and timing thresholds calculated by the origin service 510.

As shown in FIG. 6, the timing diagram 600 begins with a segment start 602 at time T0. Time T0 represents the wall-clock time when a new media segment is generated by a pipeline 502. From time T0, the origin service 510 calculates a first threshold T1 and a second threshold T2. The first threshold T1 is defined as a slower generation time among encoders assigned to a geographic area, where the slower generation time is based on a first segment arrival time observed for the pipelines 502, a segment duration, and a requested segment identifier, which is then increased by a configurable jitter guard such as 100 milliseconds. The second threshold T2 is defined as the slower generation time among the encoders based on the first segment arrival time, the segment duration, and the requested segment identifier, which is then increased by a configurable deadline such as three seconds. In deployments that include more than two pipelines 502, the slower generation time is determined among the pipelines 502 included in a regional priority list managed by the origin service 510.

The period between the segment start 602 and the first threshold T1 is labeled as a denial window 610. During the denial window 610, the requested segment is not expected to be available from any pipeline 502. Accordingly, when the origin service 510 receives a segment request during the denial window 610, the origin service 510 rejects the segment request immediately without performing any pipeline scan, which reduces unnecessary database load and prevents premature fallback to backup pipelines 502.

The period between the first threshold T1 and the second threshold T2 is labeled as an opportunistic fetch window 606. During the opportunistic fetch window 606, the origin service 510 transmits a request for the segment to a preferred pipeline 502. When the preferred pipeline 502 has already generated the requested segment, the origin service 510 returns the requested segment. When the preferred pipeline 502 has not yet generated the requested segment, the origin service 510 rejects the segment request, which prevents the request from being satisfied by another pipeline 502 and thereby avoids playback inconsistencies that may result from unsynchronized segment generation by the pipelines 502.

The period after the second threshold T2 is labeled as a sequential search window 612. During the sequential search window 612, the origin service 510 transmits requests for the segment sequentially to pipelines 502 in a fixed order of priority, which may include a preferred pipeline located in a local region, a preferred pipeline located in a remote region, a backup pipeline located in the local region, and a backup pipeline located in the remote region. The origin service 510 returns the requested segment from the first pipeline 502 in the priority order that generates the segment. When none of the pipelines 502 in the priority order has generated the requested segment, the origin service 510 returns an error response to indicate that the segment is unavailable.

Accordingly, the timing diagram 600 illustrates how the origin service 510 enforces timing thresholds and operational windows relative to segment requests and expected segment generation times. The denial window 610 prevents wasteful queries, the opportunistic fetch window 606 reduces latency while preserving consistency, and the sequential search window 612 ensures resiliency by allowing backup pipelines 502 to be used when necessary. The combination of such windows balances consistency, latency, and scalability within the example architecture 600.

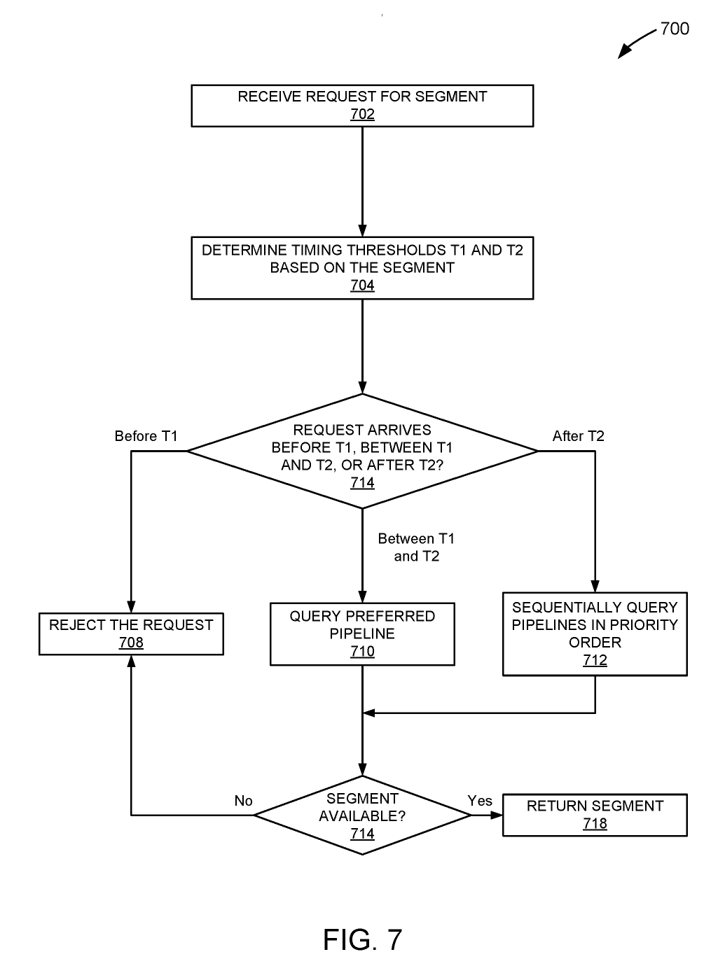

FIG. 7 illustrates an example flow diagram 700 for processing segment requests in the example network infrastructure 500 described in conjunction with FIG. 5, according to some embodiments. More specifically, the flow diagram 700 illustrates how the origin service 510 applies timing thresholds to determine whether a segment request should be rejected, handled opportunistically by a preferred pipeline 502, or resolved through sequential searching among different pipelines 502.

As shown in FIG. 7, the flow diagram 700 begins at step 702, where the origin service 510 receives a request for a segment of media content. At step 704, the origin service 510 determines timing thresholds T1 and T2 based on an expected segment generation time for the requested segment, the observed arrival time of earlier segments, the segment duration, and the requested segment identifier. As described herein, the threshold T1 incorporates a jitter guard, while threshold T2 incorporates a deadline.

At step 706, the origin service 510 evaluates whether the request arrives before T1, between T1 and T2, or after T2. If the request arrives before T1, then the origin service 510 rejects the request at step 708, because the segment is not expected to be available from any pipeline 502. If the request arrives between T1 and T2, then the origin service 510 transmits a query at step 710 to a preferred pipeline 502 identified in a priority list. If the preferred pipeline 502 has generated the segment, as determined at step 714, then the origin service 510 returns the segment at step 718. Otherwise, the origin service 510 rejects the request.

If the request arrives after T2, then the origin service 510 initiates sequential querying at step 712. In particular, the origin service 510 queries the pipelines 502 in a fixed order of priority, which may include a preferred pipeline 502 in a local region, a preferred pipeline 502 in a remote region, a backup pipeline 502 in the local region, and a backup pipeline 502 in the remote region. If a queried pipeline 502 has generated the requested segment, as determined at step 714, then the origin service 510 returns the segment at step 718. If no pipeline 502 has generated the segment, then the origin service 510 returns an error response indicating that the segment is unavailable.

In sum, the disclosed techniques provide a live streaming system in which multiple redundant pipelines generate and provide packaged media segments to geographically distributed origin services, and an origin service determines from which pipeline a requested segment should be obtained. The disclosed techniques improve upon prior approaches by introducing a structured retrieval process that defines two timing boundaries relative to the expected availability of each segment. A first boundary is defined as the expected segment-availability time plus a jitter guard time, and a second boundary is defined as the expected segment-availability time plus a longer deadline.

Requests that arrive before the first boundary are rejected with a HyperText Transfer Protocol (HTTP) 404 not-found response, which helps to prevent premature lookups and avoid unnecessary database queries when a segment cannot yet be available. Requests that arrive between the first boundary and the second boundary are handled opportunistically by performing a single fetch from a preferred pipeline. If the segment is available through the preferred pipeline, then the segment is retrieved from the preferred pipeline. Conversely, if the segment is not available through the preferred pipeline, then the request is rejected with an HTTP 404 not-found response, and no further pipeline scanning is carried out. Requests that arrive after the second boundary trigger a successive pipeline scan, in which the origin service checks the pipelines in a fixed order until a valid segment is located. If the segment cannot be obtained from the pipelines, then an HTTP 404 not-found response is returned.

One technical advantage of the disclosed techniques relative to prior approaches is that the disclosed techniques improve consistency of pipeline selection and efficiency of request handling in live streaming systems. By preventing segment requests from being prematurely satisfied by backup pipelines, the disclosed techniques reduce “ping-ponging,” in which segment retrieval alternates between pipelines that are not time-synchronized or fully interchangeable. Reducing pipeline ping-ponging preserves uniform sourcing of consecutive segments and lowers the likelihood of timing differences, frame alignment mismatches, or encoding inconsistencies that manifest as jitter, stutter, dropped frames, or audio discontinuities during playback. The disclosed techniques also reduce wasted processing when requested segments are not yet available by rejecting premature segment requests and deferring retrieval from backup pipelines until retrieval is likely to succeed. Reducing unnecessary retrieval attempts lowers the volume of unsuccessful database lookups, conserves processing resources, and improves responsiveness for segment requests that arrive at appropriate times. These technical advantages provide one or more technological advancements over prior art approaches.

1. In some embodiments, a computer-implemented method for processing requests for media content segments in a live video streaming system comprises: receiving, from an endpoint device, a first request for a segment of media content; determining, based on an expected generation time associated with the segment, a first timing threshold and a second timing threshold; if the first request is received between the first timing threshold and the second timing threshold, then: transmitting a second request for the segment to a preferred pipeline included in a plurality of pipelines, and returning the segment to the endpoint device if the segment is available from the preferred pipeline, or returning an error to the endpoint device if the segment is not available from the preferred pipeline; and if the first request is received after the second timing threshold, then: transmitting a third request for the segment to at least one pipeline included in the plurality of pipelines, and returning the segment to the endpoint device if the segment is available from any pipeline included in the plurality of pipelines, or returning an error to the endpoint device if the segment is not available from any of the pipelines included in the plurality of pipelines.

2. The computer-implemented method of clause 1, wherein determining the first timing threshold and the second timing threshold comprises applying a jitter guard time to the expected generation time.

3. The computer-implemented method of any of clauses 1-2, wherein the expected generation time is based on a segment generation schedule associated with the plurality of pipelines.

4. The computer-implemented method of any of clauses 1-3, wherein the plurality of pipelines includes at least the preferred pipeline and at least one backup pipeline.

5. The computer-implemented method of any of clauses 1-4, wherein the third request is transmitted to the at least one pipeline in accordance with a fixed order of priority across the pipelines included in the plurality of pipelines.

6. The computer-implemented method of any of clauses 1-5, wherein the preferred pipeline is assigned a highest priority across the pipelines included in the plurality of pipelines.

7. The computer-implemented method of any of clauses 1-6, wherein returning an error comprises returning a HyperText Transfer Protocol (HTTP) 404 not-found response.

8. The computer-implemented method of any of clauses 1-7, wherein determining whether the segment is available from a particular pipeline included in the plurality of pipelines comprises executing at least one database query associated with the particular pipeline.

9. The computer-implemented method of any of clauses 1-8, wherein the at least one database query includes an identifier associated with the segment.

10. The computer-implemented method of any of clauses 1-9, wherein the media content segments are associated with a live streaming event.

11. In some embodiments, one or more non-transitory computer readable storage media include instructions that, when executed by one or more processors, cause the one or more processors to process requests for media content segments in a live video streaming system, by performing the steps of: receiving, from an endpoint device, a first request for a segment of media content; determining, based on an expected generation time associated with the segment, a first timing threshold and a second timing threshold; if the first request is received between the first timing threshold and the second timing threshold, then: transmitting a second request for the segment to a preferred pipeline included in a plurality of pipelines, and returning the segment to the endpoint device if the segment is available from the preferred pipeline, or returning an error to the endpoint device if the segment is not available from the preferred pipeline; and if the first request is received after the second timing threshold, then: transmitting a third request for the segment to at least one pipeline included in the plurality of pipelines, and returning the segment to the endpoint device if the segment is available from any pipeline included in the plurality of pipelines, or returning an error to the endpoint device if the segment is not available from any of the pipelines included in the plurality of pipelines.

12. The one or more non-transitory computer readable storage media of clause 11, wherein the steps further include, if the first request is received before the first timing threshold: returning an error to the endpoint device.

13. The one or more non-transitory computer readable storage media of any of clauses 11-12, wherein the third request is successively transmitted to each pipeline included in the plurality of pipelines until the segment is identified as being available in the pipeline.

14. The one or more non-transitory computer readable storage media of any of clauses 11-13, wherein the expected generation time is based on a slowest generation time across the pipelines included in the plurality of pipelines.

15. The one or more non-transitory computer readable storage media of any of clauses 11-14, wherein determining the first timing threshold and the second timing threshold comprises applying a jitter guard time to the expected generation time.

16. The one or more non-transitory computer readable storage media of any of clauses 11-15, wherein the expected generation time is based on a segment generation schedule associated with the plurality of pipelines.

17. The one or more non-transitory computer readable storage media of any of clauses 11-16, wherein the plurality of pipelines includes at least the preferred pipeline and at least one backup pipeline.

18. The one or more non-transitory computer readable storage media of any of clauses 11-17, wherein the third request is transmitted to the at least one pipeline in accordance with a fixed order of priority across the pipelines included in the plurality of pipelines.

19. The one or more non-transitory computer readable storage media of any of clauses 11-18, wherein the preferred pipeline is assigned a highest priority across the pipelines included in the plurality of pipelines.

20. In some embodiments, a system comprises one or more memories storing instructions, and one or more processors coupled to the one or more memories and that, when executing the instructions, perform the steps of: receiving, from an endpoint device, a first request for a segment of media content; determining, based on an expected generation time associated with the segment, a first timing threshold and a second timing threshold; if the first request is received between the first timing threshold and the second timing threshold, then: transmitting a second request for the segment to a preferred pipeline included in a plurality of pipelines, and returning the segment to the endpoint device if the segment is available from the preferred pipeline, or returning an error to the endpoint device if the segment is not available from the preferred pipeline; and if the first request is received after the second timing threshold, then: transmitting a third request for the segment to at least one pipeline included in the plurality of pipelines, and returning the segment to the endpoint device if the segment is available from any pipeline included in the plurality of pipelines, or returning an error to the endpoint device if the segment is not available from any of the pipelines included in the plurality of pipelines.

Any and all combinations of any of the claim elements recited in any of the claims and/or any elements described in this application, in any fashion, fall within the contemplated scope of the present invention and protection.

The descriptions of the various embodiments have been presented for purposes of illustration, but are not intended to be exhaustive or limited to the embodiments disclosed. Many modifications and variations will be apparent to those of ordinary skill in the art without departing from the scope and spirit of the described embodiments.

Aspects of the present embodiments may be embodied as a system, method or computer program product. Accordingly, aspects of the present disclosure may take the form of an entirely hardware embodiment, an entirely software embodiment (including firmware, resident software, micro-code, etc.) or an embodiment combining software and hardware aspects that may all generally be referred to herein as a “module,” a “system,” or a “computer.” In addition, any hardware and/or software technique, process, function, component, engine, module, or system described in the present disclosure may be implemented as a circuit or set of circuits. Furthermore, aspects of the present disclosure may take the form of a computer program product embodied in one or more computer readable medium(s) having computer readable program code embodied thereon.

Any combination of one or more computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine. The instructions, when executed via the processor of the computer or other programmable data processing apparatus, enable the implementation of the functions/acts specified in the flowchart and/or block diagram block or blocks. Such processors may be, without limitation, general purpose processors, special-purpose processors, application-specific processors, or field-programmable gate arrays.

The flowchart and block diagrams in the figures illustrate the architecture, functionality, and operation of possible implementations of systems, methods and computer program products according to various embodiments of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

While the preceding is directed to embodiments of the present disclosure, other and further embodiments of the disclosure may be devised without departing from the basic scope thereof, and the scope thereof is determined by the claims that follow.

What is claimed is:

1. A computer-implemented method for processing requests for media content segments in a live video streaming system, the method comprising:
receiving, from an endpoint device, a first request for a segment of media content;
determining, based on an expected generation time associated with the segment, a first timing threshold and a second timing threshold;
if the first request is received between the first timing threshold and the second timing threshold, then:
transmitting a second request for the segment to a preferred pipeline included in a plurality of pipelines, and
returning the segment to the endpoint device if the segment is available from the preferred pipeline, or returning an error to the endpoint device if the segment is not available from the preferred pipeline; and
if the first request is received after the second timing threshold, then:
transmitting a third request for the segment to at least one pipeline included in the plurality of pipelines, and
returning the segment to the endpoint device if the segment is available from any pipeline included in the plurality of pipelines, or returning an error to the endpoint device if the segment is not available from any of the pipelines included in the plurality of pipelines.

2. The computer-implemented method of claim 1, wherein determining the first timing threshold and the second timing threshold comprises applying a jitter guard time to the expected generation time.

3. The computer-implemented method of claim 1, wherein the expected generation time is based on a segment generation schedule associated with the plurality of pipelines.

4. The computer-implemented method of claim 1, wherein the plurality of pipelines includes at least the preferred pipeline and at least one backup pipeline.

5. The computer-implemented method of claim 1, wherein the third request is transmitted to the at least one pipeline in accordance with a fixed order of priority across the pipelines included in the plurality of pipelines.

6. The computer-implemented method of claim 5, wherein the preferred pipeline is assigned a highest priority across the pipelines included in the plurality of pipelines.

7. The computer-implemented method of claim 1, wherein returning an error comprises returning a HyperText Transfer Protocol (HTTP) 404 not-found response.

8. The computer-implemented method of claim 1, wherein determining whether the segment is available from a particular pipeline included in the plurality of pipelines comprises executing at least one database query associated with the particular pipeline.

9. The computer-implemented method of claim 8, wherein the at least one database query includes an identifier associated with the segment.

10. The computer-implemented method of claim 1, wherein the media content segments are associated with a live streaming event.

11. One or more non-transitory computer readable storage media including instructions that, when executed by one or more processors, cause the one or more processors to process requests for media content segments in a live video streaming system, by performing the steps of:
receiving, from an endpoint device, a first request for a segment of media content;
determining, based on an expected generation time associated with the segment, a first timing threshold and a second timing threshold;
if the first request is received between the first timing threshold and the second timing threshold, then:
transmitting a second request for the segment to a preferred pipeline included in a plurality of pipelines, and
returning the segment to the endpoint device if the segment is available from the preferred pipeline, or returning an error to the endpoint device if the segment is not available from the preferred pipeline; and
if the first request is received after the second timing threshold, then:
transmitting a third request for the segment to at least one pipeline included in the plurality of pipelines, and
returning the segment to the endpoint device if the segment is available from any pipeline included in the plurality of pipelines, or returning an error to the endpoint device if the segment is not available from any of the pipelines included in the plurality of pipelines.

12. The one or more non-transitory computer readable storage media of claim 11, wherein the steps further include, if the first request is received before the first timing threshold:
returning an error to the endpoint device.

13. The one or more non-transitory computer readable storage media of claim 11, wherein the third request is successively transmitted to each pipeline included in the plurality of pipelines until the segment is identified as being available in the pipeline.

14. The one or more non-transitory computer readable storage media of claim 11,
wherein the expected generation time is based on a slowest generation time across the pipelines included in the plurality of pipelines.

15. The one or more non-transitory computer readable storage media of claim 11, wherein determining the first timing threshold and the second timing threshold comprises applying a jitter guard time to the expected generation time.

16. The one or more non-transitory computer readable storage media of claim 11, wherein the expected generation time is based on a segment generation schedule associated with the plurality of pipelines.

17. The one or more non-transitory computer readable storage media of claim 11, wherein the plurality of pipelines includes at least the preferred pipeline and at least one backup pipeline.

18. The one or more non-transitory computer readable storage media of claim 11, wherein the third request is transmitted to the at least one pipeline in accordance with a fixed order of priority across the pipelines included in the plurality of pipelines.

19. The one or more non-transitory computer readable storage media of claim 11, wherein the preferred pipeline is assigned a highest priority across the pipelines included in the plurality of pipelines.

20. A system, comprising:
one or more memories storing instructions; and
one or more processors coupled to the one or more memories that, when executing the instructions, perform the steps of:
receiving, from an endpoint device, a first request for a segment of media content;
determining, based on an expected generation time associated with the segment, a first timing threshold and a second timing threshold;
if the first request is received between the first timing threshold and the second timing threshold, then:
transmitting a second request for the segment to a preferred pipeline included in a plurality of pipelines, and
returning the segment to the endpoint device if the segment is available from the preferred pipeline, or returning an error to the endpoint device if the segment is not available from the preferred pipeline; and
if the first request is received after the second timing threshold, then:
transmitting a third request for the segment to at least one pipeline included in the plurality of pipelines, and
returning the segment to the endpoint device if the segment is available from any pipeline included in the plurality of pipelines, or returning an error to the endpoint device if the segment is not available from any of the pipelines included in the plurality of pipelines.
